(19) United States
(12) Patent Application Publication
(10) Pub. No.: US 2020/0031200 A1
(43) Pub. Date: Jan. 30, 2020

(54) Ventilating device for ventilating an interior of a motor vehicle

(71) Applicant: UMFOTEC GMBH, Northeim (DE)

(72) Inventors: Ralf Buck, Kipfenberg (DE); Jan Biermann, München (DE)

(21) Appl. No.: 16/338,225

(22) PCT Filed: Sep. 29, 2017
(86) PCT No.: PCT/EP2017/074781

§ 371 Date: Mar. 29, 2019

(30) Foreign Application Priority Data
Sep. 30, 2016 (DE) 10 2016 118 583.3

(51) Int. Cl. B60H 1/24

(52) U.S. Cl. CPC B60H 1/248; B60H 2001/006

(57) ABSTRACT

The invention relates to a venting device for venting an interior of a motor vehicle, including an air guiding element, which comprises at least one air outlet for venting the interior, and including an acoustic damping element disposed in the air guiding element, by means of which a sound pressure level occurring at the air outlet can be reduced. In order to provide such a venting device with improved acoustic characteristics, it is provided that the damping element is formed as a Helmholtz resonator.

The invention relates to a venting device for venting an interior of a motor vehicle according to the preamble of claim 1.

Such a venting device is already known from the vehicle construction, wherein porous materials are typically employed there as acoustic damping measure. Based on the principle of an absorption sound damper, thereby, acoustic energy—for example arising by turbulences—can be partially absorbed, that is converted to heat and thus sound pressure or a sound pressure level can be reduced. However, due to the characteristics of the used and available materials as well as the usually limited installation space, only a limited damping effect in a limited frequency range is achieved. In addition, this damped frequency range is adaptable or controllable only to a limited extent.

It is the object of the invention to provide a venting device with improved acoustic characteristics.

According to the invention, this object is solved by a venting device having the features of claim 1. Advantageous implementations of the invention are the subject matter of the dependent claims and the description.

A venting device according to the invention is characterized in that the acoustic damping element is formed as a Helmholtz resonator. In other words, thus, the functional principle of a resonance absorber is employed here for sound absorption. Thereto, the Helmholtz resonator includes a cavity or a chamber, which at least mostly encloses or surrounds an air volume and comprises at least one opening. Therein, the opening has a lower extension or a lower diameter than the enclosed air volume and thus establishes a relatively tight or narrow connection between it and an environment of the damping element, in particular with the air guided in the air guiding element outside of the damping element. Preferably, the opening can have a cylindrical shape with a length measured along the cylinder axis, which can preferably be less than an extension of the chamber measured in the same direction. Thus, a mass-spring system overall arises, in which the air in the area of the opening serves as an oscillating mass and the air volume enclosed in the chamber serves as the spring. Thus, acoustic energy is converted into mechanical energy or a collective oscillation of the mass and optionally dissipated as heat via friction effects. Here, the employment of a Helmholtz resonator is particularly advantageous since matching of the frequency and resonance or absorption behavior, respectively, to respectively present circumstances of the motor vehicle is possible by a corresponding design and adaptation of the geometry. Thus, a sound and frequency spectrum, respectively, arising in a motor vehicle in the area of the venting device or the respective air outlet and an associated intensity distribution of the sound can be considerably dependent on and be influenced by the respectively optionally very complex geometry of the air guiding element and a plurality of further factors optionally not or only hardly influenceable. Due to the functional principle and the possible specific tunability, effective reduction of the occurring sound pressures and sound pressure levels, respectively, can be advantageously achieved by means of the Helmholtz resonator also in the middle and low frequency ranges, which is not possible by conventional porous sound absorbers in practice or not to significant and sufficient extent, respectively. Therein, it is further particularly advantageous that the Helmholtz resonator requires installation space lower by a multiple with comparable efficiency and has a considerably higher efficiency with utilization of the available limited installation space. In addition, the Helmholtz resonator can be manufactured from a very simply manageable, robust and inexpensive matter or material such as for instance a plastic. A further advantage is that the utilized operating principle relies or is based on geometric characteristics or shape characteristics of the damping element and thus disadvantageous effects such as for instance material aging or material consumption are prevented or at least minimized.

In terms of the present invention, acoustic frequencies between zero and a few hundred hertz are regarded as deep or low frequencies. Frequencies of a few kilohertz and more are regarded as high-frequency. The range between low and high frequencies includes middle frequencies. Therein, the transitions between these ranges are smooth and an efficiency of both conventional sound absorbing porous materials and the damping element according to the invention is also correspondingly not severely limited to certain frequencies.

In further configuration of the invention, it is provided that the damping element is formed by a plurality of Helmholtz resonators coupled to each other. In other words, the acoustic damping element can further be integrally formed, however, therein comprise multiple chambers with respective openings. However, the cavities or interiors of each two chambers adjoining to each other are therein not directly connected to each other, that is, they are—at least along the respective connecting or boundary surface or surfaces—tight or terminated with respect to each other. The respective openings each establish or represent a direct connection between the respective cavity or interior of the chamber and the air volume enclosed by the chamber, respectively, and an interior, interior area or flow area of the air guiding element and the air guided in the air guiding element, respectively. Thus, the openings are disposed in flow direction. The chambers are coupled to each other via these openings with intervention of the air guided in the air guiding element or the air volume located in the air guiding element. Thus, the air volumes enclosed in the chambers are also coupled to each other.

By the coupling of multiple chambers, which can in particular also be of different shape and size, the damping element now also comprises a plurality of different resonant frequencies and an overall particularly advantageously more wideband sound damping effect with respect to a simple Helmholtz resonator. The openings of the chambers can advantageously be matched or adapted to each other such that an overall effect improving the action or a corresponding interaction of the chambers arises. Thus, the chambers can positively influence each other, that is, by the cooperation or an interaction between the chambers, a damping effect and acoustics improved in particular with respect to a single Helmholtz resonator can be achieved.

In further configuration of the invention, it is provided that the damping element comprises a plurality of in particular round openings. By a corresponding smart selection of the sizes and the arrangement of the openings, adaptation or matching of the acoustic characteristics, that is, of the frequency or damping behavior of the damping element, can be achieved and performed, respectively. In particular, multiple openings can respectively be provided in the area of each chamber and in the area of each resonance volume of the damping element, respectively. This advantageously allows configuration as flexible as possible to achieve an optimum effect. However, the openings can therein also have other shapes and for example have a slit-like configuration. It is also conceivable and possible to combine multiple different shapes and to provide multiple openings with different shapes, respectively. Therein, the openings and the shape or shapes thereof can be configured and/or matched or adapted to each other such that additional, undesired sound—for example whistling noises—does not arise upon flowing over the openings by the air guided in the air guiding element besides the sound damping effect.

In further configuration of the invention, the damping element comprises a plurality of openings of the same size and openings with at least two different sizes. In other words, the multiple openings of the damping elements are distributed to at least two, but principally arbitrarily many, different sizes and diameters, respectively. Therein, one or a plurality of openings can be provided for each size and these respective numbers can each be identical or different in pairs for the different sizes. Therein, it can in particular be provided that a chamber of the damping element respectively comprises only openings of at least substantially uniform size. Overall, at least two, in particular three, chambers can be provided, wherein at least one chamber comprises openings, which have a size other than the openings of at least one further chamber. Hereby too, the spectral damping behavior of the damping element can advantageously be particularly flexibly and exactly adjusted.

Of course, the respective opening or the respective openings can be flexibly configured and adapted in particular with respect to the respective shape and size both with one and with multiple chambers to achieve an optimum effect.

With multiple openings in or on a single chamber, coupling via a common spring element effectively arises, wherein the openings or bores or apertures or passages and an air volume respectively located therein, respectively, act as a mechanical mass. Multiple chambers can act as single Helmholtz elements on their own, but therein be coupled among each other, to each other or with each other as described.

In further configuration of the invention, it is provided that sound pressure levels occurring at different air outlets of the venting device provided for venting the interior are matched to each other by means of the damping element. In other words, the air guiding element comprises a plurality of, in particular two, air outlets spaced from each other and disposed immediately at a bounding element or in an edge area of the interior and the damping element is configured and adapted such that the noises occurring at the air outlets and exiting the air outlets, respectively, are as similar to each other as possible in their volume and their spectrum and their spectral intensity distribution, respectively, by its sound damping effect. Thus, the corresponding noises perceived by a respective vehicle occupant are thereby balanced with respect to the different air outlets such that an aural impression as uniform and pleasant as possible arises for the vehicle occupant. Advantageously, this can result in increased and improved quality impression, respectively, as well as in a reduced risk of distraction and in reduced symptoms of irritation and/or fatigue, respectively, and thus finally contribute to increased driving safety. According to arrangement of the different air outlets, the damping element can be adapted to generate sound levels and acoustic frequency spectra as symmetric as possible in an area spatially centrally centered between the air outlets and/or in an area typically occupied by a respective vehicle occupant.

In further formation of the invention, it is provided that the air guiding element comprises two air guiding channels of different length extending from an air inlet or an air inlet area of the air guiding element up to a respective air outlet provided for venting the interior and the damping element is disposed in the shorter air guiding channel. Thus, the air guiding element can comprise a single common air inlet or air inlet area, to which a plurality of air guiding channels adjoins, via which the respective air outlets are finally supplied with air. The air inlet or air inlet area can also comprise separating elements, which constitute a respective wall or boundary of an air guiding channel or the air guiding channels such that a direct connection of multiple air guiding channels to each other does not necessarily exist. The arrangement of the damping element in the shorter air guiding channel is particularly advantageous since sound levels occurring at the air outlet associated with the shorter air guiding channel are typically higher than at the other air outlets associated with a longer air guiding channel. Thus, sound damping and balancing can be particularly effectively realized by this arrangement.

In further formation of the invention, it is provided that a sound absorbing material, in particular a foam or a non-woven fabric, is disposed in the air guiding element in addition to the damping element. The additional sound absorbing material thus relies on a principle other than the damping element in its effect, wherein a plurality of other, in particular porous materials is also usable or employable besides foams and non-woven fabrics. For example, relatively high frequencies can be particularly effectively damped by the sound absorbing porous material, while middle and low frequencies can be particularly effectively damped by the damping element. Thus, an even more flexible and better matching of the sound damping overall effect of the venting device can be particularly advantageously achieved due to the different modes of operation and characteristics of the additional sound absorbing material and the damping element. Thus, according to geometry, available installation space and typical background noise, both sound damping measures can for example be matched to each other in their arrangement, extension and configuration and thereby finally in their effect.

In further formation of the invention, it is provided that the damping element is formed of a non-foamed plastic at least for the most part. This particularly advantageously allows manufacture as inexpensive as possible as well as particularly simple manageability of the damping element. Furthermore, a damping element thus manufactured can be particularly simply and securely disposed and retained, respectively, or attached on or in the air guiding element with low effort. Hereto, diverse different fixing means or types, such as for instance screw, rivet, plug and/or adhesive connections, can be suitable.

In further configuration of the invention, it is provided that the damping element at least substantially completely extends across a cross-section of the air guiding element. In particular, the shape of the damping element can correspond to a cross-section of an air guiding channel, in which the damping element is disposed. In order to still ensure sufficient air throughput through the corresponding air guiding channel, the damping element can comprise respective openings on its opposing sides extending in the corresponding cross-sectional plane of the air guiding channel. At the same time, such an arrangement advantageously ensures that sound waves cannot propagate along the air guiding channel and for example past the damping element up to the interior of the motor vehicle in unimpeded manner. Such an arrangement can be particularly advantageous if the cross-section of the air guiding element is relatively large since the damping element can withdraw energy from the acoustic medium, that is the air, only up to a limited depth.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations or alone.

Now, the invention is explained in more detail based on a preferred embodiment as well as with reference to the drawings. There show:

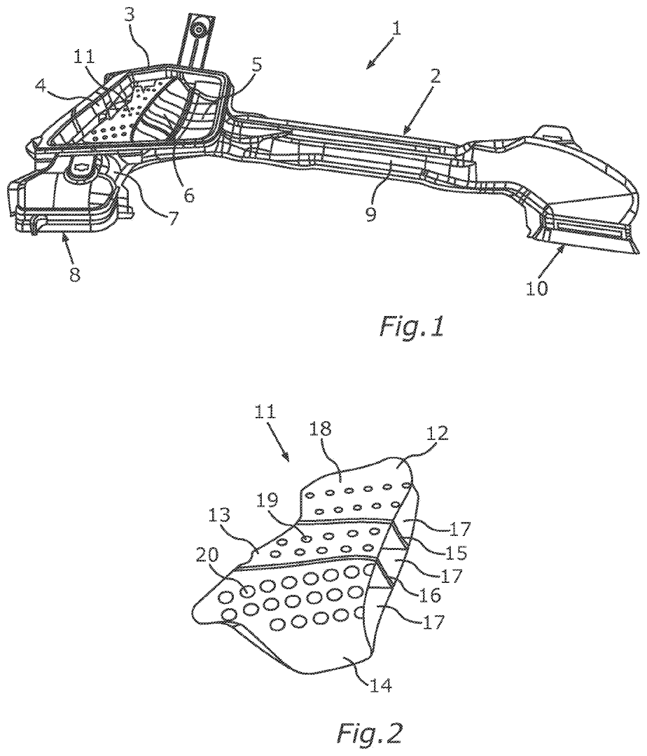

FIG. 1 in schematic and perspective representation, a venting device for venting an interior of a motor vehicle, which comprises two differently long air guiding channels as a part of an air guiding element as well as an acoustic damping element disposed in the air guiding element; and

FIG. 2 a schematic perspective view of an acoustic damping element formed by three coupled Helmholtz resonators.

FIG. 1 shows a venting device 1 for venting an interior of a motor vehicle, which is formed by an air guiding element 2 for the most part, in a schematic perspective view. The latter comprises an air inlet area 3 with a first air inlet 4 and a second air inlet 5, which are separated from each other by a separating element 6. Furthermore, the air guiding element 2 includes a short air guiding channel 7, which connects the first air inlet 4 to a first air outlet 8, and a long air guiding channel 9, which connects the second air inlet 5 to a second air outlet 10. A damping element 11 is disposed in the first air inlet 4 or in a transitional area between the first air inlet 4 and the short air guiding channel 7 as a part of the venting device 1. Therein, the damping element 11 at least substantially extends across the entire cross-section of the first air inlet 4 and of the short air guiding channel 7, respectively, and comprises a correspondingly complex and irregularly shaped outer contour, respectively.

Known conventional and often employed venting devices also comprise air guiding or climate channels and in particular often very short middle channels—here corresponding to the short air guiding channel 7—and considerably longer side channels—here corresponding to the long air guiding channel 9. Therein, these differently long channels exhibit a considerably different acoustic transmitting behavior such that noises transmitted by the different channels and propagating along these channels, respectively, and exiting respective air outlets are severely different and asymmetric, respectively. In order to reduce a volume, that is a sound pressure and a sound pressure level, respectively, sound absorbing porous materials can be provided in the channels, but which exhibit an appreciable effect only in a limited, in particular relatively high frequency range.

In order to achieve sound damping and balance and decrease as far as possible, respectively, of the acoustic differences between the first air outlet 8 and the second air outlet 10 also in middle and low frequency ranges, it is therefore presently provided that the damping element 11 is formed as a Helmholtz resonator and is disposed in the area of the short air guiding channel 7. Typically, a sound pressure level of noises for example arising by turbulences can be lower by for example 10 to 15 decibel in the area of the second air outlet 10 than in the area of the first air outlet 8 if a correspondingly configured damping element 11 is not provided. The short air guiding channel 7 and the first air outlet 8, respectively, is therefore dominant in an acoustic perception of a vehicle occupant, wherein the differences can in particular be present in the middle frequency ranges between for example 800 and 3000 hertz. Especially in this frequency range, a considerably better noise reducing effect can be achieved by a Helmholtz resonator than by means of conventional sound absorbing materials.

Unlike presently illustrated, the damping element 11 can also be disposed at another location between the air inlet area 3 and the first air outlet 8, wherein a correspondingly adapted shaping and design can then optionally be required. A sound absorbing porous material such as for instance a foam or a non-woven fabric is preferably additionally disposed in one or both of the air guiding channels 7, 9—here not recognizable, wherein the effects of this material and the damping element 11 are matched to each other to achieve sound pressure level reduction over a frequency range as wide as possible and an acoustic impression overall as harmonic as possible for the respective vehicle occupant or occupants.

According to arrangement of the air guiding element 2 in the respective motor vehicle, the first air outlet 8 and the second air outlet 10 can for example be disposed in an instrument panel of the motor vehicle and for example on both sides of a steering wheel or in opposing lateral end areas of the instrument panel. Principally, the air guiding element 2 can also comprise more than two air guiding channels, which optionally can also comprise one or more branches to respective further air outlets between the air inlet area 3 and respective air outlets. Similarly, multiple damping elements 11 formed as Helmholtz resonators can also be provided in one, multiple or all of the air guiding channels. If multiple damping elements 11 are provided, thus, they are advantageously to be differently configured or designed and thus to be matched in their damping behavior to realize background noise as harmonic and symmetric as possible with a sound pressure level as low as possible. Thus, a respective damping efficiency can for example be adjusted depending on the length of the respective air guiding channel, in which the respective damping element 11 is disposed, such that damping elements 11 disposed in longer air guiding channels effect lower reduction of the respective local sound pressure level.

FIG. 2 shows the damping element 11 from FIG. 1 in a schematic perspective view. Presently, the damping element 11 comprises a three-chamber construction with correspondingly three coupled Helmholtz resonators. Thereto, the damping element 11 comprises a first segment 12, a second segment 13 and a third segment 14, wherein the first segment 12 is separated from the second segment 13 by a first partition 15 and the second segment 13 is separated from the third segment 14 by a second partition 16. Therein, the first partition 15 and the second partition 16 together with corresponding sections of the outer walls of the damping element 11 constitute respective boundaries of respective chambers or interior areas 17 of the individual segments 12, 13, 14. In order to achieve the coupling of the segments 12, 13, 14 and the respective interior areas 17, respectively, the first partition 15 and the second partition 16 comprise respective passage openings or apertures. In order to realize the mode of operation of a Helmholtz resonator, a plurality of openings 18, 19, 20 are respectively provided at the individual segments 12, 13, 14. These openings 18, 19, 20 connect the respective interior areas 17 of the segments 12, 13, 14 to an environmental region of the damping element 11 and thereby presently to a volume at least partially enclosed by the short air guiding channel 7 and the air inlet area 3, respectively. An exact position, number and size of the openings 18, 19, 20 can be utilized for exact and adequate matching of the acoustic behavior of the damping element 11 like the respective size and configuration of the interior areas 17 and optionally also the coupling openings in the partitions 15, 16. Presently, the first segment 12 and the second segment 13 comprise an at least approximately regular pattern of openings 18, 19 formed of two rows, wherein the openings 18 of the first segment 12 and the openings 19 of the second segment 13 all have a uniform size. Hereto, a diameter of the openings 18, 19 of 3 millimeters can for example be provided. Presently, the third segment 14 comprises an also at least approximately regular pattern of openings 20, but formed of three rows deviating therefrom. Presently, the openings 20 of the third segment 14 are of identical, uniform size to each other, but have a larger diameter than the openings 18, 19 of the segments 12, 13. Presently, a respective diameter of 15 millimeters can for example be provided for the openings 20 of the third segment 14.

According to corresponding requirements and circumstances and a geometry of the air guiding element 2, the damping element 11 can also be formed with a deviating number and/or size and/or configuration of the segments 12, 13, 14, of the corresponding partitions 15, 16 and the openings 18, 19, 20.

In order to be able to produce the damping element 11 in its presently illustrated complex configuration as inexpensive as possible, it is preferably manufactured from an in particular non-foamed plastic. However, a design in other materials such as for instance a metal would principally also be conceivable. Therein, it is important that sufficient stiffness is ensured to prevent the sound damping effect from being impaired for example by a fluid-structure interaction in the area of the resonator, that is of the damping element 11. The same also applies to the air guiding element 2, wherein a combination of different matters and materials is well also conceivable to for example achieve cost as low as possible, a weight as low as possible and therein sufficient stability at the same time.

The damping element 11 can also be disposed in the air guiding element 2 in an installation position other than illustrated here and either does not have to necessarily extend across the entire local cross-section of the short air guiding channel 7. For example, it can also be conceivable to dispose the damping element 11 at a wall area of the short air guiding channel 7 and therein to leave free a part of the cross-section of the short air guiding channel 7 to allow sufficient air throughput.

### LIST OF REFERENCE CHARACTERS

1 venting device
2 air guiding element
3 air inlet area
4 first air inlet
5 second air inlet
6 separating element
7 short air guiding channel
8 first air outlet
9 long air guiding channel
10 second air outlet
11 damping element
12 first segment
13 second segment
14 third segment
15 first partition
16 second partition
17 interior areas
18, 19, 20 openings

1. A venting device for venting an interior of a motor vehicle, including an air guiding element, which comprises at least one air outlet for venting the interior, and including an acoustic damping element that is formed as a Helmholtz resonator disposed in the air guiding element, by means of which a sound pressure level occurring at the air outlet can be reduced,
wherein
the damping element comprises at least two chambers, wherein one chamber each comprises several openings of uniform size and wherein one of the chambers has openings, which have a different size than the openings of the at least one further chamber.

2. The venting device according to claim 1,
wherein
the damping element is formed by a plurality of Helmholtz resonators coupled to each other.

3. The venting device according to claim 1,
wherein
the damping element comprises a plurality of in particular round openings.

4. The venting device according to claim 3,
wherein
the damping element comprises a plurality of openings of the same size and openings with at least two different sizes.

5. The venting device according to claim 1,
wherein
sound pressure levels are matched to each other by means of the damping element at different air outlets of the venting device provided for venting the interior.

6. The venting device according to claim 1,
wherein
the air guiding element comprises two air guiding channels of different length extending from an air inlet up to a respective air outlet provided for venting the interior and the damping element is disposed in the shorter air guiding channel.

7. The venting device according to claim 1,
wherein
a sound absorbing material, in particular a foam or non-woven fabric, is disposed in the air guiding element in addition to the damping element.

8. The venting device according to claim 1,
wherein
the damping element is formed of a non-foamed plastic at least in large part.

9. The venting device according to the preceding claim 1,
wherein
the damping element at least substantially completely extends across a cross-section of the air guiding element.
